(19) United States
(12) Patent Application Publication
(10) Pub. No.: US 2022/0317708 A1
(43) Pub. Date: Oct. 6, 2022

(54) UNMANNED AERIAL VEHICLE PROTECTION METHOD AND APPARATUS AND UNMANNED AERIAL VEHICLE

(71) Applicant: AUTEL ROBOTICS CO., LTD., Shenzhen (CN)

(72) Inventors: Minghua LU, Shenzhen (CN); Kangli WANG, Shenzhen (CN)

(21) Appl. No.: 17/808,452

(22) Filed: Jun. 23, 2022

Related U.S. Application Data
(63) Continuation of application No. PCT/CN2020/133961, filed on Dec. 4, 2020.

(30) Foreign Application Priority Data
Dec. 25, 2019 (CN) 201911360353.1

(51) Int. Cl. G05D 1/10; B64C 39/02; B64D 45/04; G08G 5/00

(52) U.S. Cl. CPC G05D 1/101; B64C 39/024; B64D 45/04; G08G 5/0069; B64C 2201/127; B64C 2201/141

(57) ABSTRACT

Embodiments of the present invention relate to an unmanned aerial vehicle protection method and apparatus and an unmanned aerial vehicle. The method includes: switching the unmanned aerial vehicle to an attitude mode after a positioning system of the unmanned aerial vehicle fails; controlling the unmanned aerial vehicle in the attitude mode and reducing a height of the unmanned aerial vehicle; and controlling the unmanned aerial vehicle to land safely when obtained ground environment information meets a preset landing condition. By adopting the foregoing method, the unmanned aerial vehicle can safely and smoothly land on the ground after a positioning sensor of the unmanned aerial vehicle fails, thereby reducing the probability of explosion of the unmanned aerial vehicle and improving the flight safety of the unmanned aerial vehicle.

### CROSS-REFERENCE TO RELATED APPLICATIONS

The present application is a continuation of International Application No. PCT/CN2020/133961, filed on Dec. 4, 2020, which claims priority to Chinese Patent Application No. 201911360353.1, filed on Dec. 25, 2019, which is incorporated herein by reference in its entirety.

### TECHNICAL FIELD

The present invention relates to the field of unmanned aerial vehicle technologies and in particular, to an unmanned aerial vehicle protection method and apparatus and an unmanned aerial vehicle.

### BACKGROUND

With the continuous development of aerial photography technologies for unmanned aerial vehicles, more and more consumer-grade unmanned aerial vehicles are produced and developed. Unmanned aerial vehicles are becoming increasingly popular. There are many manners of controlling an unmanned aerial vehicle, for example, controlling the unmanned aerial vehicle through a mobile terminal such as a remote control, a mobile phone or a computer.

However, during the flight of the unmanned aerial vehicle, location control mainly relies on location coordinates provided by GPS outdoors and mainly relies on a location provided by a binocular vision algorithm indoors. When GPS and binocular vision are effective, it can be ensured that the location of the unmanned aerial vehicle in any air remains unchanged, that is, the unmanned aerial vehicle is in a location mode. However, the working environment of the unmanned aerial vehicle is relatively complex. In areas with interference, GPS signals become very poor or even the unmanned aerial vehicle cannot receive GPS signals. When the weather is relatively poor, the binocular vision positioning manner is also greatly affected. When both the GPS and the binocular vision positioning manner fail, the unmanned aerial vehicle switches the flight mode from the location mode to an attitude mode through a status controller. However, the attitude mode has a characteristic of random floating around, so that there is a possibility of unmanned aerial vehicle explosion at any time, which is very dangerous.

### SUMMARY

To resolve the foregoing technical problem, the embodiments of the present invention provide an unmanned aerial vehicle protection method and apparatus and an unmanned aerial vehicle, which can reduce the probability of explosion of the unmanned aerial vehicle and improve the flight safety in a case that a positioning sensor of the unmanned aerial vehicle fails.

To resolve the foregoing technical problem, an embodiment of the present invention provides the following technical solution: an unmanned aerial vehicle protection method, applicable to an unmanned aerial vehicle, the method including:

switching the unmanned aerial vehicle to an attitude mode after a positioning system of the unmanned aerial vehicle fails;

controlling the unmanned aerial vehicle in the attitude mode and reducing a height of the unmanned aerial vehicle;

obtaining ground environment information; and

controlling the unmanned aerial vehicle to land safely when the ground environment information meets a preset landing condition.

Optionally, the switching the unmanned aerial vehicle to an attitude mode after a positioning system of the unmanned aerial vehicle fails includes:

keeping a pitch angle and a roll angle of the unmanned aerial vehicle within a preset angle range after the positioning system of the unmanned aerial vehicle fails.

Optionally, the preset angle range is −2° to 2°.

Optionally, after the keeping a pitch angle and a roll angle of the unmanned aerial vehicle within a preset angle range after the positioning system of the unmanned aerial vehicle fails, the method further includes:

controlling a heading angle of the unmanned aerial vehicle to remain unchanged or controlling the unmanned aerial vehicle to rotate at a preset yaw angle rate.

Optionally, the controlling the unmanned aerial vehicle in the attitude mode and reducing a height of the unmanned aerial vehicle includes:

reducing the height of the unmanned aerial vehicle in the attitude mode of remaining the heading angle of the unmanned aerial vehicle unchanged or controlling the unmanned aerial vehicle to rotate at the preset yaw angle rate.

Optionally, after the switching the unmanned aerial vehicle to an attitude mode after a positioning system of the unmanned aerial vehicle fails, the method further includes:

controlling the unmanned aerial vehicle to raise to a preset height;

determining whether positioning data is obtained; and

controlling, if the positioning data is not obtained, the unmanned aerial vehicle in the attitude mode and reducing the height of the unmanned aerial vehicle.

Optionally, the controlling the unmanned aerial vehicle to land safely when the ground environment information meets a preset landing condition includes:

obtaining landing safety determining information according to the ground environment information; and

controlling the unmanned aerial vehicle to land safely according to the landing safety determining information.

Optionally, the landing safety determining information includes safe landing information and dangerous landing information; and the controlling the unmanned aerial vehicle to land safely according to the landing safety determining information includes:

controlling the unmanned aerial vehicle to hover and keep still when the landing safety determining information is the dangerous landing information;

obtaining a manual control instruction and controlling the unmanned aerial vehicle to deviate from a current location according to the manual control instruction; and

continuously controlling the unmanned aerial vehicle to continue to land, for the unmanned aerial vehicle to land safely.

To resolve the foregoing technical problem, an embodiment of the present invention further provides the following technical solution: an unmanned aerial vehicle protection apparatus. The unmanned aerial vehicle protection apparatus includes: a mode switching module, configured to switch an unmanned aerial vehicle to an attitude mode after a positioning system of the unmanned aerial vehicle fails;

a height reduction module, configured to control the unmanned aerial vehicle in the attitude mode and reduce a height of the unmanned aerial vehicle;

a ground environment information obtaining module, configured to obtain ground environment information; and

a landing control module, configured to control the unmanned aerial vehicle to land safely when the ground environment information meets a preset landing condition.

To resolve the foregoing technical problem, an embodiment of the present invention further provides the following technical solution: an unmanned aerial vehicle. The unmanned aerial vehicle includes: a body;

arms connected to the body;

power apparatuses, disposed on the arms and configured to provide power for flight of the unmanned aerial vehicle;

a flight controller, disposed on the body; and

a ground detection sensor, configured to obtain ground environment information, where

the flight controller includes:

at least one processor; and

a memory communicatively connected to the at least one processor, where the memory stores instructions executable by the at least one processor and the instructions are executed by the at least one processor, to cause the at least one processor to be configured to perform the foregoing unmanned aerial vehicle protection method.

Compared with the prior art, according to the unmanned aerial vehicle protection method provided in the embodiments of the present invention, after the positioning system of the unmanned aerial vehicle fails, the unmanned aerial vehicle is switched to the attitude mode; the unmanned aerial vehicle is controlled in the attitude mode and the height of the unmanned aerial vehicle is reduced; and the unmanned aerial vehicle is then controlled to land safely when the ground environment information meets the preset landing condition. By adopting the foregoing method, the unmanned aerial vehicle can safely and smoothly land on the ground after the positioning sensor of the unmanned aerial vehicle fails, thereby reducing the probability of explosion of the unmanned aerial vehicle and improving the flight safety of the unmanned aerial vehicle.

### BRIEF DESCRIPTION OF THE DRAWINGS

One or more embodiments are exemplarily described with reference to the corresponding figures in the accompanying drawings and the descriptions are not to be construed as limiting the embodiments. Components in the accompanying drawings that have same reference numerals are represented as similar components and unless otherwise particularly stated, the figures in the accompanying drawings are not drawn to scale.

FIG. 1 is a schematic diagram of an application environment according to an embodiment of the present invention;

FIG. 2 is a schematic flowchart of an unmanned aerial vehicle protection method according to one embodiment of the present invention;

FIG. 3 is a schematic flowchart of an unmanned aerial vehicle protection method according to another embodiment of the present invention;

FIG. 4 is a schematic flowchart of S40 in FIG. 2;

FIG. 5 is a schematic flowchart of S42 in FIG. 4;

FIG. 6 is a structural block diagram of an unmanned aerial vehicle protection apparatus according to an embodiment of the present invention; and

FIG. 7 is a structural block diagram of an unmanned aerial vehicle according to an embodiment of the present invention.

### DETAILED DESCRIPTION

For ease of understanding the present invention, the present invention is described in more detail below with reference to the accompanying drawings and specific embodiments. It should be noted that, when a component is expressed as “being fixed to” another component, the component may be directly on the another component, or one or more intermediate components may exist between the component and the another component. When one component is expressed as “being connected to” another component, the component may be directly connected to the another component, or one or more intermediate components may exist between the component and the another component. In the description of this specification, orientation or position relationships indicated by the terms such as “up”, “down”, “inside”, “outside” and “bottom” are based on orientation or position relationships shown in the accompanying drawings and are used only for ease and brevity of illustration and description of the present invention, rather than indicating or implying that the mentioned apparatus or component needs to have a particular orientation or needs to be constructed and operated in a particular orientation. Therefore, such terms should not be construed as limiting of the present invention. In addition, terms “first”, “second” and “third” are only used to describe the objective and cannot be understood as indicating or implying relative importance.

Unless otherwise defined, meanings of all technical and scientific terms used in the present invention are the same as that usually understood by a person skilled in the art to which the present invention belongs. In the present invention, terms used in the specification of the present invention are merely intended to describe objectives of the specific embodiments, but are not intended to limit the present invention. A term “and/or” used in this specification includes any or all combinations of one or more related listed items.

In addition, technical features involved in different embodiments of the present invention described below may be combined if there is no conflict.

Embodiments of the present invention provide an unmanned aerial vehicle protection method and apparatus.

An application environment of the unmanned aerial vehicle protection method and apparatus is illustrated below.

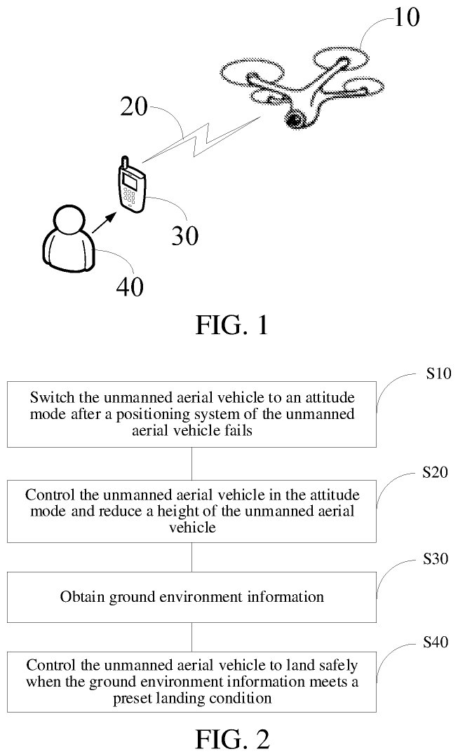

FIG. 1 is a schematic diagram of an application environment of an unmanned aerial vehicle protection system according to an embodiment of the present invention. As shown in FIG. 1, the application environment includes an unmanned aerial vehicle 10, a wireless network 20, a smart terminal 30 and a user 40. The user 40 may operate the smart terminal 30 to control the unmanned aerial vehicle 10 through the wireless network 20.

The unmanned aerial vehicle 10 may be any type of power-driven unmanned aerial vehicle, including, but not limited to, a rotary-wing unmanned aerial vehicle, a fixed-wing unmanned aerial vehicle, a para-wing unmanned aerial vehicle, a flapping-wing unmanned aerial vehicle and a helicopter model. In this embodiment, a multi-rotary-wing unmanned aerial vehicle is described as an example.

The unmanned aerial vehicle 10 may have a corresponding volume or power according to an actual requirement, to provide a load capacity, a flight speed and a flight mileage that can meet a use requirement. One or more sensors may be further added to the unmanned aerial vehicle 10, so that the unmanned aerial vehicle 10 can acquire corresponding data.

For example, in this embodiment, the unmanned aerial vehicle 10 is provided with at least one sensor of an accelerometer, a gyroscope, a magnetometer, a GPS navigator or a vision sensor.

The unmanned aerial vehicle 10 further includes a flight controller, which serves as a control core of the unmanned aerial vehicle for flight and data transmission and integrates one or more modules to execute corresponding logic control programs. For example, the flight controller may be configured to perform the foregoing unmanned aerial vehicle protection method.

The smart terminal 30 may be any type of smart apparatus configured to establish a communication connection to the unmanned aerial vehicle 10, for example, a mobile phone, a tablet computer, a smart remote control or the like. The smart terminal 30 may be equipped with one or more types of different interaction apparatuses of the user 40, which are configured to acquire an instruction of the user 40 or present or feed back information to the user 40.

The interaction apparatuses include, but are not limited to, a button, a display screen, a touchscreen, a speaker and a remote control joystick. For example, the smart terminal 30 may be equipped with a touch display screen. Through the touch display screen, a remote control instruction for the unmanned aerial vehicle 10 is received from the user 40 and image information obtained through aerial photography is presented to the user 40. The user 40 may further switch the image information currently displayed on the display screen through a remote touchscreen.

In some embodiments, the existing image visual processing technology may be further fused between the unmanned aerial vehicle 10 and the smart terminal 30 to further provide more intelligent services. For example, the unmanned aerial vehicle 10 may acquire images through a dual-light camera. The smart terminal 30 analyzes the images, to implement gesture control for the unmanned aerial vehicle 10 by the user 40.

The wireless network 20 may be a wireless communication network configured to establish a data transmission channel between two nodes based on any type of data transmission principle, for example, a Bluetooth network, a Wi-Fi network, a wireless cellular network or a combination thereof located in different signal frequency bands.

FIG. 2 is an embodiment of an unmanned aerial vehicle protection method according to an embodiment of the present invention. As shown in FIG. 2, the unmanned aerial vehicle protection method may be performed by a flight controller of an unmanned aerial vehicle. The method includes the following steps:

S10: Switch the unmanned aerial vehicle to an attitude mode after a positioning system of the unmanned aerial vehicle fails.

Specifically, that the positioning system of the unmanned aerial vehicle fails means that positioning sensors of the unmanned aerial vehicle, including GPS, binocular vision and other apparatuses, cannot provide effective location data or cannot provide indirect data for obtaining a location.

During the flight of the unmanned aerial vehicle, location control mainly relies on location coordinates provided by GPS outdoors and mainly relies on a location provided by a binocular vision algorithm indoors. When GPS and binocular vision are effective, it can be ensured that the location of the unmanned aerial vehicle in any air remains unchanged, that is, the unmanned aerial vehicle is in a location mode. However, the working environment of the unmanned aerial vehicle is relatively complex. In areas with interference, GPS signals become very poor or even the unmanned aerial vehicle cannot receive GPS signals. When the weather is relatively poor, the binocular vision positioning manner is also greatly affected. When both the GPS and the binocular vision positioning manner fail, the unmanned aerial vehicle switches the flight mode from the location mode to an attitude mode through a status controller.

The attitude mode is one of basic control modes of the unmanned aerial vehicle. The control objective is to make an attitude angle and a height of the unmanned aerial vehicle converge to expected values. When there is no stick or other control command input, the unmanned aerial vehicle keeps a roll angle and a pitch angle close to zero. That is, the unmanned aerial vehicle remains close to horizontal, a heading angle remains unchanged at a current angle and the unmanned aerial vehicle height remains unchanged. The performance in the air is as follows: The unmanned aerial vehicle flight remains unchanged. The body of the unmanned aerial vehicle is close to horizontal. The unmanned aerial vehicle randomly floats around due to wind interference or attitude angle control errors. The attitude mode is an abnormal operating mode of the unmanned aerial vehicle, which has a characteristic of random floating around and is dangerous to a certain extent. The dependent sensors include a gyroscope, an accelerometer, a magnetometer, a barometer and ultrasound. Preferably, the pitch angle and the roll angle of the unmanned aerial vehicle are kept within a preset angle range after the positioning system of the unmanned aerial vehicle fails. The preset angle range is −2° to 2°.

S20: Control the unmanned aerial vehicle in the attitude mode and reduce a height of the unmanned aerial vehicle.

Specifically, the pitch angle and the roll angle of the unmanned aerial vehicle are kept within the preset angle range and the height of the unmanned aerial vehicle is reduced. In some embodiments, while the pitch angle and the roll angle of the unmanned aerial vehicle are kept within the preset angle range, the height of the unmanned aerial vehicle is reduced in the attitude mode of controlling the unmanned aerial vehicle to rotate at the preset yaw angle rate, to prevent the unmanned aerial vehicle from deviating too far from the current location during the descending in the attitude mode.

S30: Obtain ground environment information.

Specifically, the unmanned aerial vehicle is equipped with a ground detection sensor for detecting the ground environment information. The ground detection sensor may be a commonly used monocular or binocular camera. Preferably, in this embodiment, the ground detection sensor is a split camera assembly.

Specifically, in this embodiment, a plurality of struts with rotary wings are mounted on the main body of the unmanned aerial vehicle. Each strut is connected to the other struts to form joints. The split camera assembly includes: a main control board, a connecting line and a camera. The main control board is arranged at the joints. The camera is arranged between two adjacent struts of the main body of the unmanned aerial vehicle. One end of the connecting line is connected to the main control board and the other end of the connecting line is connected to the camera. The one end of the connecting line is connected to the main control board and the other end of the connecting line is connected to the camera, so that image data obtained by the camera can be transmitted to the main control board through the connecting line. In addition, the main control board is arranged at the joints formed by connecting each strut of the main body of the unmanned aerial vehicle to the other struts. The camera is arranged between two adjacent struts of the main body of the unmanned aerial vehicle. Therefore, while it is ensured that the image data obtained by the camera can be transmitted normally, the camera and the main control board are arranged at different positions of the main body of the unmanned aerial vehicle, so that the weight of the main body of the unmanned aerial vehicle is borne by different positions and the force is balanced. Therefore, while the miniaturization of the unmanned aerial vehicle is achieved, the unmanned aerial vehicle can be effectively prevented from shaking during the flight, which is more conducive to obtaining the ground environment information.

S40: Control the unmanned aerial vehicle to land safely when the ground environment information meets a preset landing condition.

Specifically, landing safety determining information is first obtained according to the ground environment information. The landing safety determining information includes safe landing information and dangerous landing information.

When the ground detection sensor detects that the ground is in a state that is not suitable for landing (for example, with water, bushes or people), the unmanned aerial vehicle may fall into the water, on trees or on pedestrians, which may probably cause explosion of the unmanned aerial vehicle or injury accidents. in this case, the obtained landing safety determining information is the dangerous landing information.

When the ground detection sensor detects that the ground is in a state suitable for landing (for example, the ground), the obtained landing safety determining information is the safe landing information.

When the landing safety determining information is the dangerous landing information, the unmanned aerial vehicle is first controlled to hover and keep still. A manual control instruction is then obtained and the unmanned aerial vehicle is controlled to deviate from the current location according to the manual control instruction. Further, the unmanned aerial vehicle is continuously controlled to continue to land, for the unmanned aerial vehicle to land safely.

Therefore, in this embodiment, after the positioning system of the unmanned aerial vehicle fails, the unmanned aerial vehicle is switched to the attitude mode; the unmanned aerial vehicle is controlled in the attitude mode and the height of the unmanned aerial vehicle is reduced; and the unmanned aerial vehicle is then controlled to land safely when the ground environment information meets the preset landing condition. By adopting the foregoing method, the unmanned aerial vehicle can safely and smoothly land on the ground after the positioning sensor of the unmanned aerial vehicle fails, thereby reducing the probability of explosion of the unmanned aerial vehicle and improving the flight safety of the unmanned aerial vehicle.

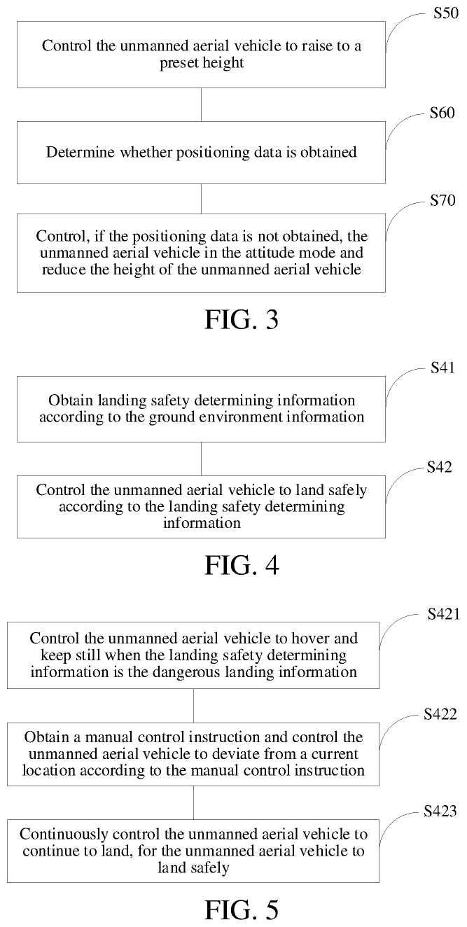

To better implement the safe landing of the unmanned aerial vehicle, in some embodiments, referring to FIG. 3, S232 includes the following steps:

S50: Control the unmanned aerial vehicle to raise to a preset height.

Specifically, an air pressure detection apparatus is used to detect that the unmanned aerial vehicle 10 raises to the preset height. The air pressure detection apparatus includes a barometer, a sensor protection cover and a conduit. The barometer is sealed in the sensor protection cover and is mounted on the unmanned aerial vehicle 10 with the sensor protection cover. One end of the conduit is in communication with the sensor protection cover. The other end of the conduit extends out of the sensor protection cover and extends upward. According to the present invention, the sensor protection cover and the conduit are arranged and the nozzle position of the tip of the conduit is arranged to extend upward, to effectively isolate the external environment where the barometer is located from the turbulence generated through rotation of paddles. Further, the barometer can be prevented from being disturbed by the unstable air pressure environment, which is beneficial to ensure the accurate detection of the pressure altitude.

S60: Determine whether positioning data is obtained.

Specifically, after the unmanned aerial vehicle raises to the preset height, it is beneficial to stay away from areas with interference, so that the unmanned aerial vehicle receives GPS signals or reduces the impact of the binocular vision positioning manner. Further, the positioning data may be re-obtained.

S70: Control, if the positioning data is not obtained, the unmanned aerial vehicle in the attitude mode and reduce the height of the unmanned aerial vehicle.

To better control the unmanned aerial vehicle to land safely when the ground environment information meets a preset landing condition, in some embodiments, referring to FIG. 4, S40 includes the following steps:

S41: Obtain landing safety determining information according to the ground environment information.

The landing safety determining information includes safe landing information and dangerous landing information.

When the ground detection sensor detects that the ground is in a state that is not suitable for landing (for example, with water, bushes or people), the unmanned aerial vehicle may fall into the water, on trees or on pedestrians, which may probably cause explosion of the unmanned aerial vehicle or injury accidents. in this case, the obtained landing safety determining information is the dangerous landing information.

When the ground detection sensor detects that the ground is in a state suitable for landing (for example, the ground), the obtained landing safety determining information is the safe landing information.

S42: Control the unmanned aerial vehicle to land safely according to the landing safety determining information.

Specifically, when the landing safety determining information is the dangerous landing information, the unmanned aerial vehicle is first controlled to hover and keep still. A manual control instruction is then obtained and the unmanned aerial vehicle is controlled to deviate from the current location according to the manual control instruction. Further, the unmanned aerial vehicle is continuously controlled to continue to land, for the unmanned aerial vehicle to land safely.

To better control the unmanned aerial vehicle to land safely when the ground environment information meets a preset landing condition, in some embodiments, referring to FIG. 5, S42 includes the following steps:

S421: Control the unmanned aerial vehicle to hover and keep still when the landing safety determining information is the dangerous landing information.

Specifically, when the landing safety determining information is the dangerous landing information, the unmanned aerial vehicle is controlled so that the location and the height of the unmanned aerial vehicle remain unchanged.

S422: Obtain a manual control instruction and control the unmanned aerial vehicle to deviate from a current location according to the manual control instruction.

Specifically, the user operates the smart terminal to control the unmanned aerial vehicle through the wireless network, so that the unmanned aerial vehicle can obtain the manual control instruction. The unmanned aerial vehicle is then controlled to deviate from the current location according to the manual control instruction. That is, the unmanned aerial vehicle is controlled, according to the manual control instruction, to deviate from an area that is currently unsuitable for landing, so that the unmanned aerial vehicle flies to an area that is suitable for landing.

S423: Continuously control the unmanned aerial vehicle to continue to land, for the unmanned aerial vehicle to land safely.

Specifically, after the unmanned aerial vehicle is controlled, according to the manual control instruction, to deviate from the area that is currently unsuitable for landing and the unmanned aerial vehicle flies to the area that is suitable for landing, the unmanned aerial vehicle is continuously controlled to continue to land, for the unmanned aerial vehicle to land safely.

It should be noted that, in the foregoing embodiments, the foregoing steps are not necessarily performed according to a specific sequence. A person of ordinary skill in the art may understand from the descriptions of the embodiments of the present application that in different embodiments, the foregoing steps may be performed according to different sequences, that is, may be performed in parallel, may be performed interchangeably or the like.

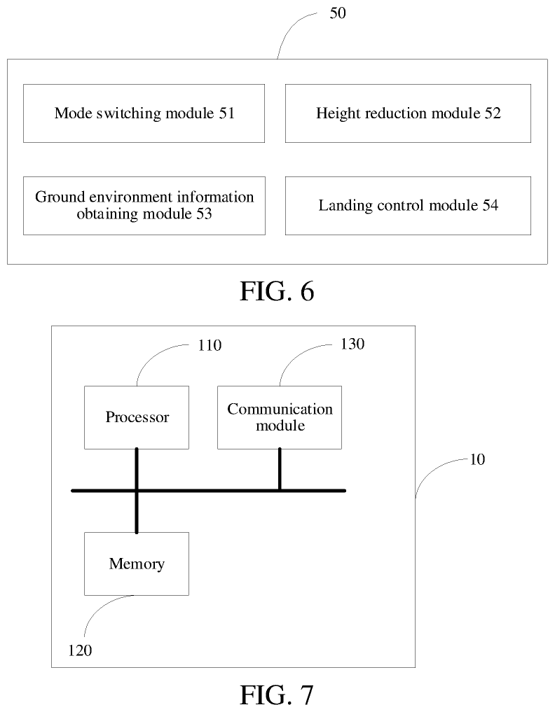

According to another aspect of the embodiments of the present application, an embodiment of the present application provides a unmanned aerial vehicle protection apparatus 50. Referring to FIG. 6, the unmanned aerial vehicle protection apparatus 50 includes: a mode switching module 51, a height reduction module 52, a ground environment information obtaining module 53 and a landing control module 54.

The mode switching module 51 is configured to switch an unmanned aerial vehicle to an attitude mode after a positioning system of the unmanned aerial vehicle fails.

The height reduction module 52 is configured to control the unmanned aerial vehicle in the attitude mode and reduce a height of the unmanned aerial vehicle.

The ground environment information obtaining module 53 is configured to obtain ground environment information.

The landing control module 54 is configured to control the unmanned aerial vehicle to land safely when the ground environment information meets a preset landing condition.

Therefore, in this embodiment, after the positioning system of the unmanned aerial vehicle fails, the unmanned aerial vehicle is switched to the attitude mode; the unmanned aerial vehicle is controlled in the attitude mode and the height of the unmanned aerial vehicle is reduced; and the unmanned aerial vehicle is then controlled to land safely when the ground environment information meets the preset landing condition. By adopting the foregoing method, the unmanned aerial vehicle can safely and smoothly land on the ground after the positioning sensor of the unmanned aerial vehicle fails, thereby reducing the probability of explosion of the unmanned aerial vehicle and improving the flight safety of the unmanned aerial vehicle.

It should be noted that, the foregoing unmanned aerial vehicle protection apparatus may perform the unmanned aerial vehicle protection method provided in the embodiments of the present invention and has the corresponding functional modules for performing the method and beneficial effects thereof. For technical details not described in detail in the embodiments of the unmanned aerial vehicle protection apparatus, reference may be made to the unmanned aerial vehicle protection method provided in the embodiments of the present invention.

FIG. 7 is a structural block diagram of an unmanned aerial vehicle 10 according to an embodiment of the present invention. As shown in FIG. 7, the unmanned aerial vehicle 10 may include: a body, arms, power apparatuses, a magnetometer, a variety of sensors, a flight controller, a ground detection sensor and a communication module 130. The flight controller includes a processor 110 and a memory 120.

The arms are connected to the body. The power apparatuses are disposed on the arms and configured to provide power for flight of the unmanned aerial vehicle.

The variety of the sensors are configured to acquire corresponding flight data respectively. The variety of sensors may be a plurality of an accelerometer, a gyroscope, a magnetometer, a GPS navigator and a vision sensor. The ground detection sensor is configured to obtain ground environment information.

Any two of the processor 110, the memory 120 and the communication module 130 are communicatively connected by a bus.

The processor 110 may be any type of processor that has one or more processing cores. The processor can perform single-threaded or multi-threaded operations and is configured to analyze instructions to perform operations such as obtaining data, performing logical operation functions and delivering operation processing results.

The memory 120, as a non-transient computer-readable storage medium, may be configured to store a non-transient software program, a non-transient computer-executable program and a module, such as program instructions/modules (for example, the mode switching module 51, the height reduction module 52, the ground environment information obtaining module 53 and the landing control module 54 shown in FIG. 6) corresponding to the unmanned aerial vehicle protection method in the embodiments of the present invention. The processor 110 executes various functional applications and data processing of the unmanned aerial vehicle protection apparatus 50 by running the non-transient software program, instructions and the modules stored in the memory 120, that is, implements the unmanned aerial vehicle protection method in any of the foregoing method embodiments.

The memory 120 may include a program storage area and a data storage area. The program storage area may store an operating system and an application program that is required for at least one function. The data storage area may store data created according to use of the unmanned aerial vehicle protection apparatus 50. In addition, the memory 120 may include a high-speed random access memory and may further include a non-transitory memory, such as at least one magnetic disk storage device, a flash memory or other non-transitory solid-state storage devices. In some embodiments, the memory 120 optionally includes memories remotely disposed relative to the processor 110 and these remote memories may be connected to the unmanned aerial vehicle 10 through a network. The foregoing examples of the network include, but are not limited to, the Internet, an intranet, a local area network, a mobile communication network and a combination thereof.

The memory 120 stores instructions executable by the at least one processor 110. The at least one processor 110 is configured to execute the instructions, to implement the unmanned aerial vehicle protection method in any of the foregoing method embodiments, for example, perform the foregoing described method steps 10, 20, 30, 40 and the like, to implement the functions of the modules 51 to 54 in FIG. 6.

The communication module 130 is a functional module configured to establish a communication connection and provide a physical channel. The communication module 130 may be any type of wireless or wired communication module 130, including but not limited to, a Wi-Fi module or a Bluetooth module and the like.

Further, an embodiment of the present invention further provides a non-transitory computer-readable storage medium. The non-transitory computer-readable storage medium stores computer executable instructions. The computer executable instructions are executed by one or more processors 110, for example, one processor 110 shown in FIG. 7, so that the one or more processors 110 perform the unmanned aerial vehicle protection method in any of the foregoing method embodiments, for example, perform the foregoing described method steps 10, 20, 30, 40 and the like, to implement the functions of the modules 51 to 54 in FIG. 6.

The foregoing described apparatus embodiments are merely examples. The units described as separate parts may or may not be physically separate and the parts displayed as units may or may not be physical units, may be located in one position or may be distributed on a plurality of network units. Some or all of the modules may be selected according to actual needs to achieve the objectives of the solutions of the embodiments.

Based on the descriptions of the foregoing implementations, a person of ordinary skill in the art may clearly understand that the implementations may be implemented by software in addition to a universal hardware platform or by hardware. A person of ordinary skill in the art may understand that all or some of procedures in the foregoing embodiment methods may be implemented by a computer program in a computer program product instructing relevant hardware. The computer program may be stored in a non-transitory computer-readable storage medium and the computer program includes program instructions. When the program instructions are executed by a related device, the related device may be enabled to execute the procedures of the foregoing method embodiments. The storage medium may be a magnetic disk, an optical disc, a read-only memory (ROM), a random access memory (RAM) or the like.

The foregoing product can perform the unmanned aerial vehicle protection method provided in the embodiments of the present invention and has the corresponding functional modules for performing the unmanned aerial vehicle protection method and beneficial effects thereof. For technical details not described in detail in this embodiment, reference may be made to the unmanned aerial vehicle protection method provided in the embodiments of the present invention.

Finally, it should be noted that the foregoing embodiments are merely used for describing the technical solutions of the present invention, but are not intended to limit the present invention. Under the ideas of the present invention, the technical features in the foregoing embodiments or different embodiments may also be combined, the steps may be performed in any order and many other changes of different aspects of the present invention also exists as described above. These changes are not provided in detail for simplicity. It should be understood by a person of ordinary skill in the art that although the present invention has been described in detail with reference to the foregoing embodiments, modifications can be made to the technical solutions described in the foregoing embodiments or equivalent replacements can be made to some technical features in the technical solutions. These modifications or replacements will not cause the essence of corresponding technical solutions to depart from the scope of the technical solutions in the embodiments of the present invention.

What is claimed is:

1. An unmanned aerial vehicle protection method, applicable to an unmanned aerial vehicle, the method comprising:
switching the unmanned aerial vehicle to an attitude mode after a positioning system of the unmanned aerial vehicle fails;
controlling the unmanned aerial vehicle in the attitude mode and reducing a height of the unmanned aerial vehicle;
obtaining ground environment information; and
controlling the unmanned aerial vehicle to land safely when the ground environment information meets a preset landing condition.

2. The method according to claim 1, wherein the switching the unmanned aerial vehicle to an attitude mode after a positioning system of the unmanned aerial vehicle fails comprises:
keeping a pitch angle and a roll angle of the unmanned aerial vehicle within a preset angle range after the positioning system of the unmanned aerial vehicle fails.

3. The method according to claim 2, wherein
the preset angle range is −2° to 2°.

4. The method according to claim 3, wherein after the keeping a pitch angle and a roll angle of the unmanned aerial vehicle within a preset angle range after the positioning system of the unmanned aerial vehicle fails, the method further comprises:
controlling a heading angle of the unmanned aerial vehicle to remain unchanged or controlling the unmanned aerial vehicle to rotate at a preset yaw angle rate.

5. The method according to claim 4, wherein the controlling the unmanned aerial vehicle in the attitude mode and reducing a height of the unmanned aerial vehicle comprises:
reducing the height of the unmanned aerial vehicle in the attitude mode of remaining the heading angle of the unmanned aerial vehicle unchanged or controlling the unmanned aerial vehicle to rotate at the preset yaw angle rate.

6. The method according to claim 5, wherein after the switching the unmanned aerial vehicle to an attitude mode after a positioning system of the unmanned aerial vehicle fails, the method further comprises:
controlling the unmanned aerial vehicle to raise to a preset height;
determining whether positioning data is obtained; and
controlling, if the positioning data is not obtained, the unmanned aerial vehicle in the attitude mode and reducing the height of the unmanned aerial vehicle.

7. The method according to claim 6, wherein the controlling the unmanned aerial vehicle to land safely when the ground environment information meets a preset landing condition comprises:
obtaining landing safety determining information according to the ground environment information; and
controlling the unmanned aerial vehicle to land safely according to the landing safety determining information.

8. The method according to claim 7, wherein
the landing safety determining information comprises safe landing information and dangerous landing information; and
the controlling the unmanned aerial vehicle to land safely according to the landing safety determining information comprises:
controlling the unmanned aerial vehicle to hover and keep still when the landing safety determining information is the dangerous landing information;
obtaining a manual control instruction and controlling the unmanned aerial vehicle to deviate from a current location according to the manual control instruction; and
continuously controlling the unmanned aerial vehicle to continue to land, for the unmanned aerial vehicle to land safely.

9. An unmanned aerial vehicle protection apparatus, applicable to an unmanned aerial vehicle, the apparatus comprising:
at least one processor; and
a memory communicatively connected to the at least one processor, wherein the memory stores instructions executable by the at least one processor and the instructions are executed by the at least one processor to cause the at least one processor to be configured to:
switch the unmanned aerial vehicle to an attitude mode after a positioning system of the unmanned aerial vehicle fails;
control the unmanned aerial vehicle in the attitude mode and reduce a height of the unmanned aerial vehicle;
obtain ground environment information; and
control the unmanned aerial vehicle to land safely when the ground environment information meets a preset landing condition.

10. The unmanned aerial vehicle protection apparatus according to claim 9, wherein the at least one processor is configured to:
keep a pitch angle and a roll angle of the unmanned aerial vehicle within a preset angle range after the positioning system of the unmanned aerial vehicle fails.

11. The unmanned aerial vehicle protection apparatus according to claim 10, wherein the preset angle range is −2° to 2°.

12. The unmanned aerial vehicle protection apparatus according to claim 11, wherein the at least one processor is configured to:
control a heading angle of the unmanned aerial vehicle to remain unchanged or control the unmanned aerial vehicle to rotate at a preset yaw angle rate.

13. The unmanned aerial vehicle protection apparatus according to claim 12, wherein the at least one processor is configured to:
reduce the height of the unmanned aerial vehicle in the attitude mode of remaining the heading angle of the unmanned aerial vehicle unchanged or controlling the unmanned aerial vehicle to rotate at the preset yaw angle rate.

14. The unmanned aerial vehicle protection apparatus according to claim 13, wherein the at least one processor is configured to:
control the unmanned aerial vehicle to raise to a preset height;
determine whether positioning data is obtained; and
control, if the positioning data is not obtained, the unmanned aerial vehicle in the attitude mode and reduce the height of the unmanned aerial vehicle.

15. The unmanned aerial vehicle protection apparatus according to claim 14, wherein the at least one processor is configured to:
obtain landing safety determining information according to the ground environment information; and
control the unmanned aerial vehicle to land safely according to the landing safety determining information.

16. The unmanned aerial vehicle protection apparatus according to claim 15, wherein the landing safety determining information comprises safe landing information and dangerous landing information; and the at least one processor is configured to:
control the unmanned aerial vehicle to hover and keep still when the landing safety determining information is the dangerous landing information;
obtain a manual control instruction and control the unmanned aerial vehicle to deviate from a current location according to the manual control instruction; and
continuously control the unmanned aerial vehicle to continue to land, for the unmanned aerial vehicle to land safely.

17. An unmanned aerial vehicle, comprising:
a body;
arms connected to the body;
power apparatuses, disposed on the arms and configured to provide power for flight of the unmanned aerial vehicle;
a flight controller, disposed on the body; and
a ground detection sensor, configured to obtain ground environment information, wherein
the flight controller comprises:
at least one processor; and
a memory communicatively connected to the at least one processor, wherein the memory stores instructions executable by the at least one processor and the instructions are executed by the at least one processor to cause the at least one processor to be configured to:
switch the unmanned aerial vehicle to an attitude mode after a positioning system of the unmanned aerial vehicle fails;
control the unmanned aerial vehicle in the attitude mode and reduce a height of the unmanned aerial vehicle;
obtain ground environment information;
control the unmanned aerial vehicle to land safely when the ground environment information meets a preset landing condition; and
control a heading angle of the unmanned aerial vehicle to remain unchanged or control the unmanned aerial vehicle to rotate at a preset yaw angle rate.

18. The unmanned aerial vehicle according to claim 17, wherein the at least one processor is configured to:
reduce the height of the unmanned aerial vehicle in the attitude mode of remaining the heading angle of the unmanned aerial vehicle unchanged or controlling the unmanned aerial vehicle to rotate at the preset yaw angle rate;
control the unmanned aerial vehicle to raise to a preset height;
determine whether positioning data is obtained; and
control, if the positioning data is not obtained, the unmanned aerial vehicle in the attitude mode and reduce the height of the unmanned aerial vehicle.

19. The unmanned aerial vehicle according to claim 18, wherein the at least one processor is configured to:
obtain landing safety determining information according to the ground environment information; and
control the unmanned aerial vehicle to land safely according to the landing safety determining information.

20. The unmanned aerial vehicle according to claim 19, wherein the landing safety determining information comprises safe landing information and dangerous landing information; and the at least one processor is configured to:
control the unmanned aerial vehicle to hover and keep still when the landing safety determining information is the dangerous landing information;
obtain a manual control instruction and control the unmanned aerial vehicle to deviate from a current location according to the manual control instruction; and
continuously control the unmanned aerial vehicle to continue to land, for the unmanned aerial vehicle to land safely.
